(19) United States
(12) Patent Application Publication
(10) Pub. No.: US 2017/0241429 A1
(43) Pub. Date: Aug. 24, 2017

(54) METHOD OF MANUFACTURING A COMPONENT OF A TURBOMACHINE, COMPONENT OF TURBOMACHINE AND TURBOMACHINE

(71) Applicant: Nuovo Pignone Srl, Florence (IT)

(72) Inventors: Gabriele MASI, Florence (IT); Michelangelo BELLACCI, Florence (IT); Filippo CAPPUCCINI, Florence (IT); Federico IOZZELLI, Florence (IT)

(21) Appl. No.: 15/314,953

(22) PCT Filed: May 28, 2015
(86) PCT No.: PCT/EP2015/061903

§ 371 Date: Nov. 30, 2016

(30) Foreign Application Priority Data
May 30, 2014 (IT) CO2014A000017

(51) Int. Cl. F04D 29/28; B22F 3/24; B33Y 80/00; B22D 25/02; B33Y 10/00; B22F 3/15; B22F 5/00

(52) U.S. Cl. CPC F04D 29/284; B22F 3/15; B22F 3/24; B22F 5/009; B22D 25/02; B33Y 10/00; B33Y 80/00; B22F 2003/153; B22F 2003/244; B22F 2003/247; B22F 2998/10

(57) ABSTRACT

A method of manufacturing a component of a turbomachine by powder metal hot isostatic pressing is disclosed, which uses a container defining outside surfaces of the component. A metal insert is located inside the container before filling the container with metal powder, and the insert is left in the component after the end of its manufacturing. In an embodiment, a metal core is located inside the container before filling the container with metal powder, and the core is removed from the component before the end of its manufacturing. In this way, net shape surfaces may be obtained without manufacturing trials.

### BACKGROUND

Embodiments of the subject matter disclosed herein relate to methods of manufacturing a component of a turbomachine, components of turbomachines and turbomachines.

One technology used for manufacturing components of turbomachines is powder metallurgy hot isostatic pressing, in short P/M-HIP; this technology is used for example for manufacturing closed impellers of centrifugal compressors made of metal material.

One of the reasons why this technology is attractive is that, through a particular approach, it allows to manufacture metal parts that do not need further machining or need limited amount of machining of the whole part or at least of some surfaces of the part; in this case, the technology is referred to as “Net-Shape HIP”; although this approach may be applied both to external surfaces and internal surfaces of a part, it is particularly useful when applied to the internal surfaces as machining of these surfaces is difficult or, sometimes, even impossible.

The cost and the time of machining depend on the type of material to be machined, the quantity of material to be removed, the accessibility of the material to be removed, and the machining technology used; for example, milling is relatively quick but a milling tool is (relatively) quite small while Electric Discharge Machining is slower but an EDM tool is (relatively) quite bigger.

In order to obtain a finished or almost-finished part, i.e. with “net shape surfaces”, it is necessary to simulate accurately the behavior of the (metal) container, the (metal) powder and the HIP equipment used for manufacturing the part.

Furthermore, even if accurate simulations are carried out, some real manufacturing trials (typically one or two or three) are necessary in order to meet the required design dimensional tolerances of complex part; after each trial, the obtained part is checked and measured and some changes are made to the container and/or to the HIP process parameters (for example the pressure curve and/or the temperature curve).

Therefore, the “net shape surfaces” approach is generally applied only to few specific surfaces and not to all surfaces of a part to be manufactured.

Simulations and trials impact on the time and the cost necessary for starting the production of a new part and, therefore, are a problem especially for single-part production or small-series production. In the field of oil & gas, there are some parts of some turbomachines that are “single parts”; in other words, such part of a turbomachine is different from any part of any turbomachine that was manufactured in the past and from any part of any turbomachine that will be manufactured in the future, even if such part may be quite similar to the past parts and to the future parts.

### BRIEF DESCRIPTION

According to the P/M-HIP technology, a container is used for defining the outside surfaces of the component to be manufactured and the container is filled with metal powder, evacuated of the gas present inside and sealed, and then the powder is consolidated by a Hot Isostatic Pressure thermal cycle; usually, the manufacturing process ends with the removal of the container; the “outside surfaces” of a body are those surfaces that delimit the body externally and therefore do not include the surfaces of through holes and of internal cavities.

P/M-HIP may also be used for manufacturing parts having one or more internal channels, including internal channels with tight tolerances such as for example working fluid flow paths; for this purpose, one or more cores have been used, in addition to the container, in order to define inside surfaces of the component, i.e. the surfaces defining the channels.

During a P/M-HIP process, when heat and pressure is applied, not only the metal powder, but also the container and the cores, if any, deform. This leads, for example, to a change in the shape, size and position of any internal channel of the manufactured part.

The higher the deformations the more manufacturing trials are necessary, as high deformations are difficult to be predicted exactly through simulation.

If deformations are sufficiently low, simulations would be necessary but real manufacturing trials would not be necessary; in this way, the time and the cost for starting the production of a new part through P/M-HIP would be reduced considerably.

It has been noted that the highest deformations are caused by those regions of the container where there is a lot of mass of metal powder that is subject to the highest shrinkage; anyway, in general, deformations can not be reduced by simply changing the shape and size of the container or the shapes and sizes of its regions because these shapes and sizes are strongly related to the shapes and sizes of the part to be manufactured.

According to an embodiment of the present invention, at least one metal insert is located inside the container before filling the container with metal powder; the metal insert is to be located in a region of the container having a big or the biggest volume, i.e. where a lot of mass of metal powder (that is subject to a high or the highest shrinkage) would locate according to a traditional P/M-HIP process; in general, more than one insert may be used.

As the metal insert is fully solid, its shrinkage during the P/M-HIP process is much smaller, typically null or almost null, than that of a corresponding mass of metal powder, and this leads to smaller overall deformations and changes in the shape and size of the manufactured part, in particular of its surfaces.

According to embodiments of the present invention, such insert is left in the part after the end of its manufacturing.

If the part to be manufactured has one or more internal channels, one or more metal cores may be located inside the container before filling the container with metal powder, and the one or more cores are removed from the part before the end of its manufacturing. In this case, also the shape, size and position of the one or more internal channels, in particular their surfaces, experience small deformations and changes (smaller than those obtained according to the prior art methods).

First exemplary embodiments relate to methods of manufacturing a component of a turbomachine by powder metal hot isostatic pressing, using a container defining outside surfaces of the component; at least one metal insert is located inside the container before filling the container with metal powder; the insert is left in the component after the end of its manufacturing. According to such embodiments, at least one metal core may be located inside the container before filling the container with metal powder; this core is removed from the component before the end of its manufacturing.

Second exemplary embodiments relate to components of a turbomachine manufactured through a method as set out above, i.e. comprising a permanent metal insert.

Third exemplary embodiments relate to turbomachines comprising at least one component as set out above.

### BRIEF DESCRIPTION OF DRAWINGS

The present invention will become more apparent from the following description of exemplary embodiments to be considered in conjunction with accompanying drawings wherein:

FIG. 1 shows a simplified cross-sectional view of a first arrangement (according to the prior art) for manufacturing a first mechanical part by powder metal hot isostatic pressing, and a corresponding turbomachine component;

FIG. 2 shows a simplified cross-sectional view of a second arrangement (according to an embodiment of the present invention) for manufacturing the first mechanical part by powder metal hot isostatic pressing, and a corresponding turbomachine component;

FIG. 3 shows a simplified cross-sectional view of a third arrangement (according to the prior art) for manufacturing a second mechanical part by powder metal hot isostatic pressing, and a corresponding turbomachine component;

FIG. 4 shows a simplified cross-sectional view of a fourth arrangement (according to an embodiment of the present invention) for manufacturing the second mechanical part by powder metal hot isostatic pressing, and a corresponding turbomachine component;

FIG. 5 shows a cross-sectional partial view of a fifth arrangement (according to an embodiment of the present invention) for manufacturing the second mechanical part by powder metal hot isostatic pressing;

FIG. 6 shows a cross-sectional partial view of a sixth arrangement (according to an embodiment of the present invention) for manufacturing the second mechanical part by powder metal hot isostatic pressing;

FIG. 7 shows a cross-sectional partial view of a seventh arrangement (according to an embodiment of the present invention) for manufacturing the second mechanical part by powder metal hot isostatic pressing; and

FIG. 8 shows a cross-sectional partial view of a eighth arrangement (according to an embodiment of the present invention) for manufacturing the second mechanical part by powder metal hot isostatic pressing.

### DETAILED DESCRIPTION

The following description of exemplary embodiments refer to the accompanying drawings. The same reference numbers in different drawings identify the same or similar elements. The following detailed description does not limit the embodiments of the invention. Instead, the scope of the embodiments is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In the following exemplary description, it must be assumed that all parts shown in the figures are manufactured by powder metal hot isostatic pressing, i.e. P/M-HIP, even if, sometimes, other technologies might be used.

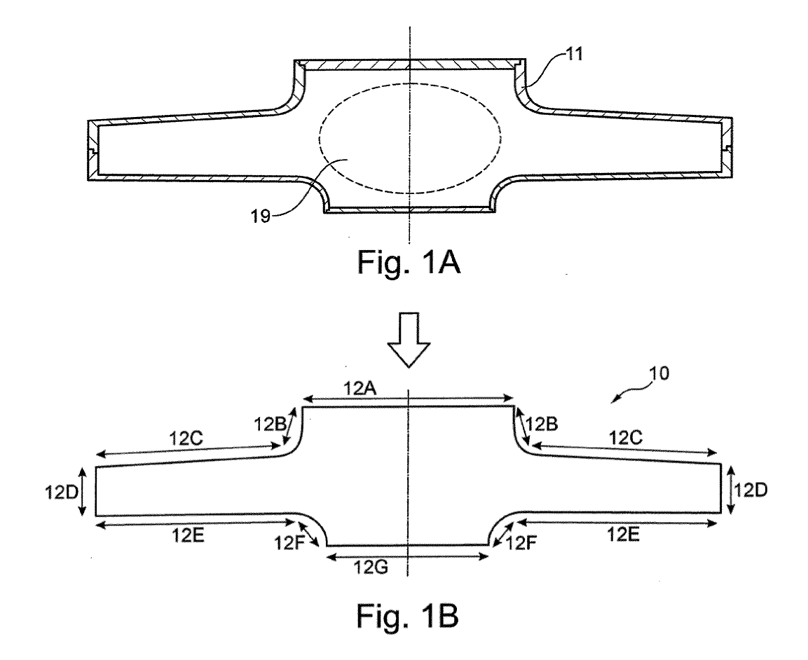

FIG. 1B shows a simplified cross-sectional view of a first turbomachine component 10, in particular a rotor wheel of a turbine, that has an axial symmetry (corresponding to the rotation axis); this component is manufactured by P/M-HIP.

FIG. 1A shows a container 11 used for manufacturing component 10 by P/M-HIP; according to this technology, the container 11 is filled with metal powder. The container 11 defines the outside surfaces of the component 10; in particular, there are a top surface 12A (substantially circular), an upper vertical surface 12B, an upper horizontal surface 12C, an intermediate vertical surface 12D, a lower horizontal surface 12E, a lower vertical surface 12F, a bottom surface 12G (substantially circular).

In the example of FIG. 1, high deformations may be caused for example by region 19 of the container 11 where there is a lot of metal powder (that is subject to high total shrinkage) when the container 11 is filled with powder; in this example, the region 19 has the shape of an ellipsoid. This means that without adequate simulations and without real manufacturing trials, all the surfaces 12A, 12B, 12C, 12D, 12E, 12F, 12G of the component 10 will have shapes, positions and sizes different from the desired ones.

It is to be noted that the shapes, positions and sizes of the walls of the container change during the P/M-HIP process; anyway, in FIG. 1, for the sake of drafting simplicity, the shapes, positions and sizes of the internal surfaces of the container 11 before the start of the process correspond to the shapes, positions and sizes of the external surfaces of the component 10 after the end of the process.

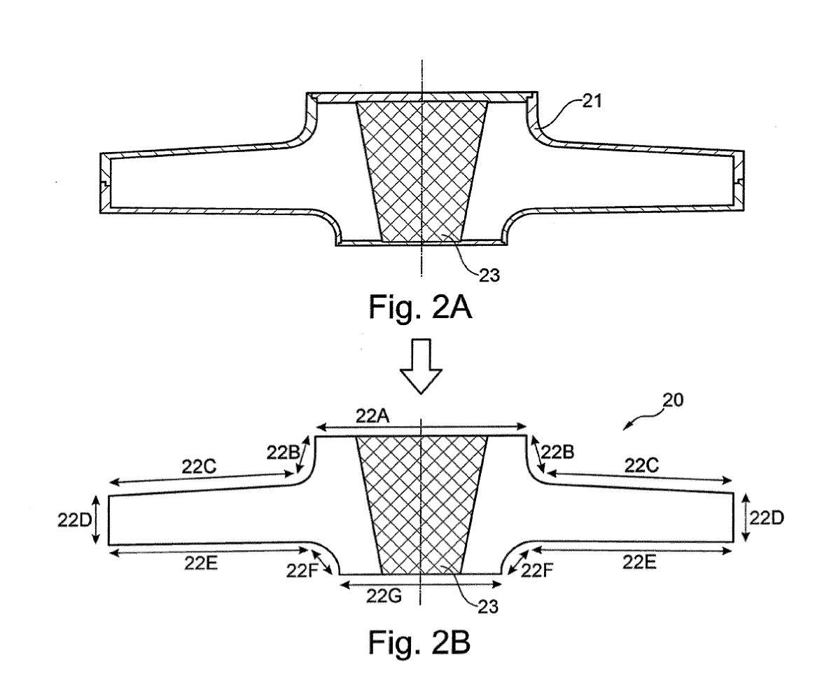

According to an embodiment of the present invention—see FIG. 2, a metal insert 23 is used for manufacturing a component 20 corresponding to the component 10 of FIG. 1; it is to be noted that the component 10 and the component 20 have identical or very similar outside surfaces but they have different structure, i.e. are different inside.

Container 21 is similar to container 11.

The insert 23 is located inside the container 21 before filling the container 21 with metal powder (see FIG. 2A) and is left in the component 20 after the end of its manufacturing (see FIG. 2B).

The insert 23 has a shaped that is similar to that of the bulk portion of the component. In this way, it's possible to reduce the space between the container and the insert during the hot isostatic pressing and consequently the thickness of the component in the area next to the insert. Since the thickness of metal in this region of the component is reduced, when the component cools the risk of shrink is reduced.

The insert 23 of the embodiment of FIG. 2 has the shape of a truncated cone and is coaxial with the container 21; it occupies most of the region 19 shown in FIG. 1A (which is important), but it extends even beyond the region 19 shown in FIG. 1A. Other shapes may be possible, such as a cone shape, a prism shape, a truncated pyramid shape, a sphere shape, an ellipsoid shape, or the like.

It is to be noted that the container 11 in FIG. 1A and the container 21 in FIG. 2A are drawn identical; for the sake of drafting simplicity; anyway, due to the presence of the insert, the two containers may be quite different because their overall deformations during the P/M-HIP process are different even if the component 10 and the component 20 have identical or very similar outside surfaces; in particular, the overall deformation of the container 11 is higher than the overall deformation of the container 21 as the material in the region 19 of the container 11 shrink much more than the corresponding region of the container 21 where there is the insert 23 (whose deformation is typically null or almost null).

In the embodiment of FIG. 2, the insert 23 has two surfaces adjacent to the container 21. Therefore, these two surfaces correspond to outside surfaces of the component 20 (see FIG. 2B); specifically, these two surfaces are portions of surfaces 22A and 22G.

Thanks to the insert 23, it will be easier to manufacture component 20 by P/M-HIP, without real manufacturing trials, with very accurate surfaces, in particular surfaces 22B and 22F that are close to the insert 23, as well as surfaces 22A and 22G.

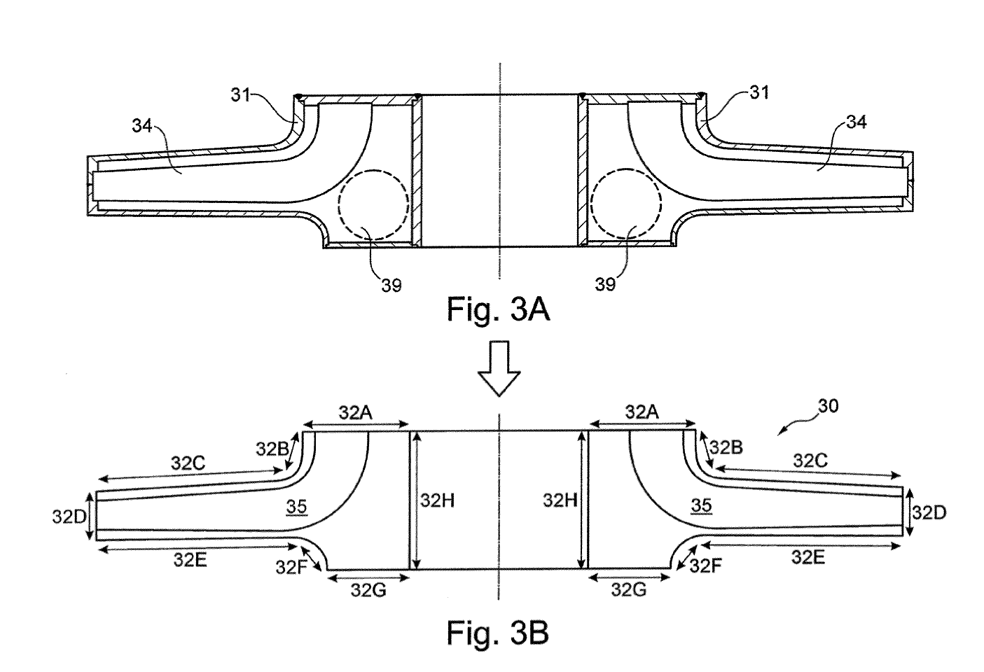

FIG. 3B shows a simplified cross-sectional view of a second turbomachine component 30, in particular a closed centrifugal impeller of a centrifugal compressor, that has an axial symmetry (corresponding to the rotation axis)(to be precise it is an antisymmetry) and an axial through hole; this component is manufactured by powder metal hot isostatic pressing, i.e. P/M-HIP.

FIG. 3A shows a container 31 used for manufacturing component 30 by P/M-HIP; according to this technology, the container 31 is filled with metal powder. The container 31 defines the outside surfaces of the component 30; in particular, there are a top surface 32A (substantially ring-shaped), an upper vertical surface 32B, an upper horizontal surface 32C, an intermediate vertical surface 32D, a lower horizontal surface 32E, a lower vertical surface 32F, a bottom surface 32G (substantially ring shaped) and an internal vertical surface 32H (that has for example a cylindrical shape and defines the through hole of the component); in this example, the container 31 has a circular through hole, but alternatively it may comprise a fully solid and rigid cylindrical part.

Furthermore, the component 30 has a plurality of internal flow paths 35; in order to define the surfaces of the plurality of through holes 35 a corresponding plurality of metal cores 34 are located inside the container 31; alternatively, the cores 34 may correspond to the arms of a single body. The metal cores are located inside the container 31 before filling the container 31 with metal powder (see FIG. 3A), and are removed from the component 30 before the end of its manufacturing (see FIG. 3B).

In the example of FIG. 3, high deformations may be caused for example by region 39 of the container 31 where there is a lot of metal powder (that is subject to high total shrinkage) when the container 31 is filled with powder; in this example, the region 39 has the shape of a ring. This means that without adequate simulations and without real manufacturing trials, all the outside surfaces 32A, 32B, 32C, 32D, 32E, 32F, 32G and 32H of the component 30 and all the inside surfaces of the component 30 (i.e. the surfaces defining the internal paths 35) will have shapes, positions and sizes different from the desired ones; this may be particularly disadvantageous for the inside surfaces as accurately machining these surfaces is difficult or, sometimes, even impossible.

It is to be noted that the shapes, positions and sizes of the walls of the container change during the P/M-HIP process; anyway, in FIG. 3, for the sake of drafting simplicity, the shapes, positions and sizes of the internal surfaces of the container 31 before the start of the process correspond to the shapes, positions and sizes of the external surfaces of the component 30 after the end of the process.

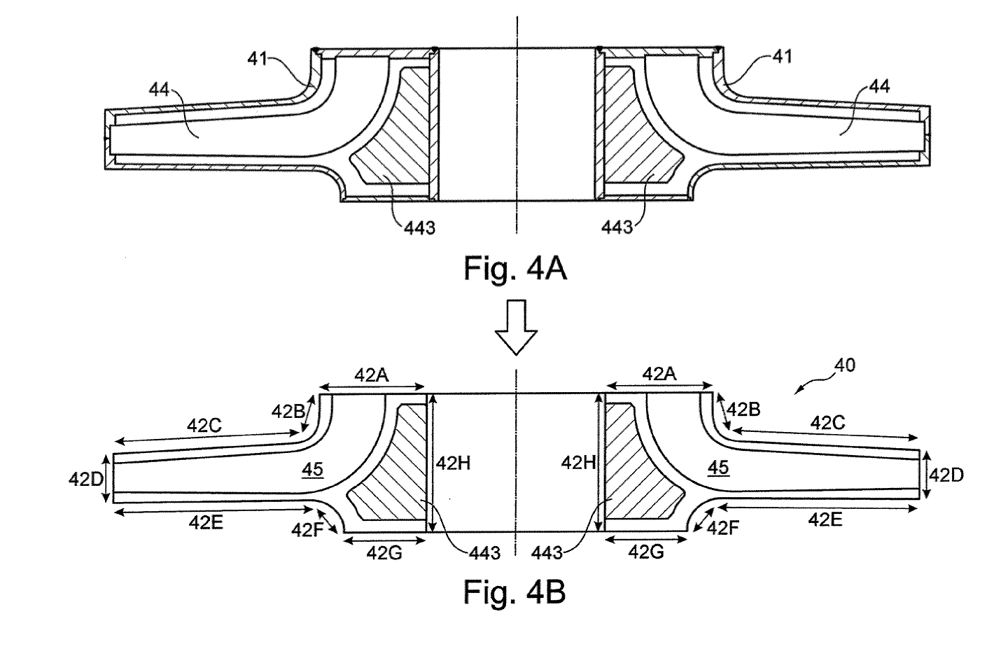

According to an embodiment of the present invention—see FIG. 4, a metal insert 443 is used for manufacturing a component 40 corresponding to the component 30 of FIG. 3; it is to be noted that the component 30 and the component 40 have identical or very similar outside surfaces but they have different structure.

Container 41 is similar to container 31.

The insert 443 is located inside the container 41 before filling the container 41 with metal powder (see FIG. 4A) and is left in the component 20 after the end of its manufacturing (see FIG. 4B).

The cores 44 are located inside the container 41 before filling the container 41 with metal powder (see FIG. 4A) and are removed from the component 40 before the end of its manufacturing (see FIG. 4B).

The insert 443 of the embodiment of FIG. 4 has the shape of a ring and is coaxial with the container 41; it occupies most of the region 39 shown in FIG. 3A (which is important), but it extends even beyond the region 39 shown in FIG. 3A. The shape of the cross-section of this ring is such as to occupy most of the space between the flow path cavities and the rotation axis of the component.

It is to be noted that the container 31 in FIG. 3A and the container 41 in FIG. 4A are drawn identical; for the sake of drafting simplicity; anyway, due to the presence of the insert, the two containers may be quite different because their deformations during the P/M-HIP process are different even if the component 30 and the component 40 have identical or very similar outside surfaces; in particular, the overall deformation of the container 31 is higher than the overall deformation of the container 41 as the material in the region 39 of the container 31 shrink much more than the corresponding region of the container 41 where there is the insert 443 (whose deformation is typically null or almost null).

In the embodiment of FIG. 4, only one insert is provided and is a bulk insert in a single piece.

In the embodiment of FIG. 4, the insert 443 has one surface adjacent to the container 41. Therefore, this surface corresponds to an outside surface of the component 40 (see FIG. 4B); specifically, this surface is a portion of surface 42H.

In the embodiment of FIG. 4, the insert 443 has no surface adjacent to the core 44 (see FIG. 4A); a surface of the insert 443 is close to the core 44 and substantially parallel.

Thanks to the insert 443, it will be easier to manufacture component 40 by P/M-HIP, without real manufacturing trials, with very accurate surfaces, in particular outside surfaces and, even more important, inside surfaces, i.e. the surfaces defining the flow paths 45 (where the cores 44 are located before removal at the end of manufacturing).

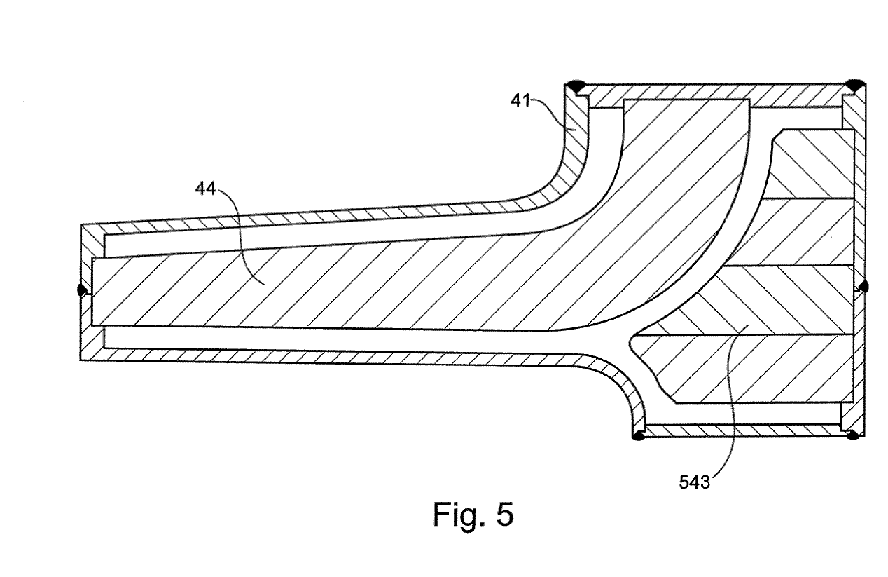

The embodiment of FIG. 5 is very similar to the embodiment of FIG. 4.

The difference consists in that the metal insert 543 is a bulk insert in a plurality of pieces; each of the pieces is ring-shaped; the pieces are separate and adjacent to each other (i.e. fully in contact) so to form a single body within the metal powder before filling the container; alternatively, for example, the pieces of the insert are separate and (a little) distant from each other so that some metal powder may fill the gap between them and facilitate bonding of these pieces. In an embodiment, the distance is in the range from 0.5 mm to 5.0 mm.

As FIG. 5 is an enlarged view, it is possible to see more details of the container 41. For example the container 41 comprises recesses designed to lock the insert 543 and the core 44; specifically, there are a first recess in the top wall and a second recess in an intermediate vertical wall of the container for locking respectively a first and a second end of the core; specifically, there is a third recess in the internal vertical wall of the container for locking and keeping them together the various pieces of the insert.

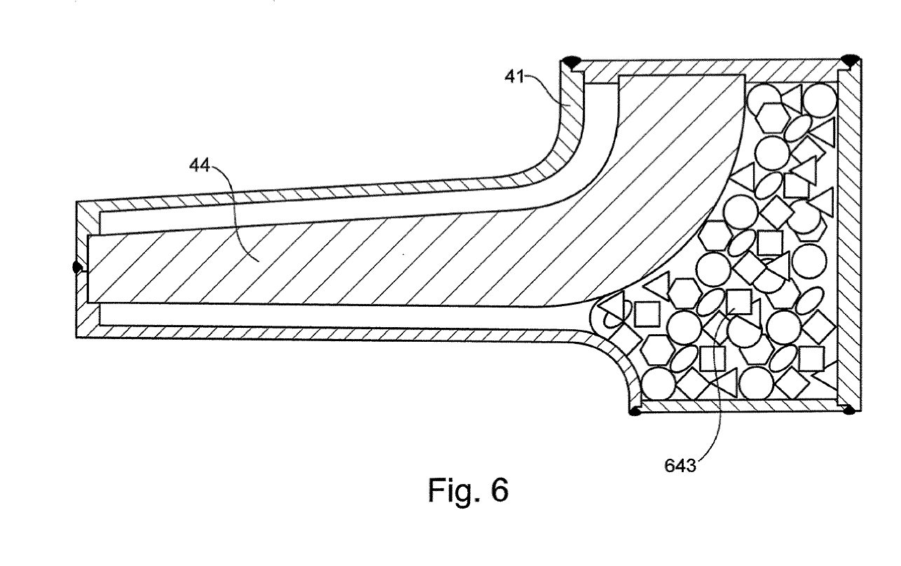

In the embodiment of FIG. 6, the metal insert 643 is a bulk insert in a plurality of pieces; the plurality of pieces are separate from each other (even if partially in contact) so to form a plurality of bodies within the metal powder before filling the container. In FIG. 6, the bodies have different shapes of geometric figures and similar size; anyway, there are many other possibilities including for example irregular figures and/or different sizes, such as for example gravel.

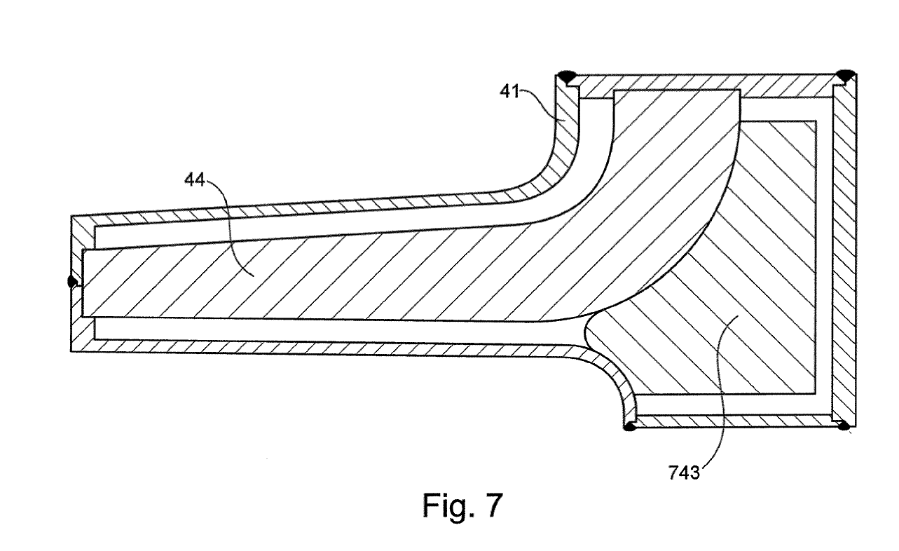

The embodiment of FIG. 7 is similar to the embodiment of FIG. 4.

The difference consists in that the metal insert 743 has a surface adjacent to the core 44.

As FIG. 7 is an enlarged view, it is possible to see more details of the container 41. For example the container 41 comprises recesses designed to lock the core 44; specifically, there are a first recess in the top wall and a second recess in an intermediate vertical wall of the container for locking respectively a first and a second end of the core.

The insert 743 is reasonably locked inside container 41 as it is ring-shaped and it is adjacent to both the cores 44 and a wall of the container 41 (see FIG. 7 below) so that it can not move.

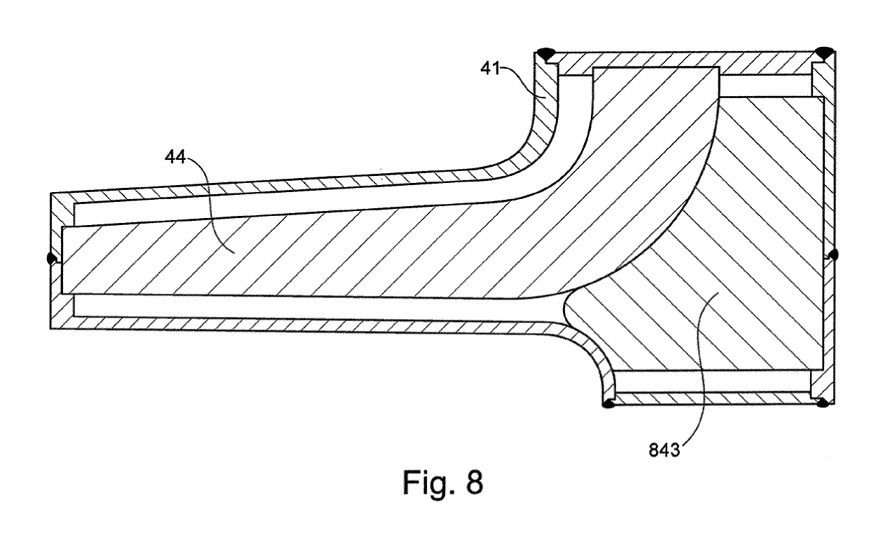

The embodiment of FIG. 8 is very similar to the embodiment of FIG. 7.

The difference consists in that the metal insert 843 has also another surface adjacent to the container.

Specifically, there is a recess in the internal vertical wall of the container for locking, even better, the insert 843.

In an embodiment, the metal material of the insert and the metal material of the powder for the P/M-HIP are the same; in this way, the two parts of the component match and join very well; furthermore, in this way, it is easier to define heat treatments for the component as the same heat treatment would work equally well for both the solid insert and the hot-pressed powder.

In principle, different materials may also be used for the insert and the powder.

One or more of the surfaces of the insert may have protrusions (e.g. ribs) and/or may be corrugated or textured or rough; if this regards a surface at the interface between the powder and the insert, a better connection between the pressed powder and the insert may be achieved and a more reliable and more strong joint may be obtained.

In an embodiment, the insert is fully solid and rigid. It is manufactured before the component, even a long time before. It may be manufactured in different ways: by powder metal hot isostatic pressing, by additive manufacturing, by forging, by casting (for example investment casting), or the like.

The container may be removed from the component before the end of its manufacturing, as it is common according to the P/M-HIP technology, and as it is shown in FIG. 1, FIG. 2, FIG. 3, FIG. 4. Usually, the container is removed by machining (for example turning or milling) and/or by pickling.

Alternatively, the container may be left, at least partially, in the component after the end of its manufacturing.

Usually, the container is made of carbon steel; if it has to be removed, it may be useful to use low carbon steel in order to facilitate removal.

As already said, the core or cores, if any, are removed from the component before the end of its manufacturing. Usually, the core or cores are removed by machining (for example drilling or milling) and/or by pickling. Usually, the core or cores are made of carbon steel, particularly low carbon steel in order to facilitate removal.

In some of the embodiments shown in the annexed figures, the metal insert is locked to the container by means of recesses in an inside wall of the container. Anyway, according to alternative embodiments, the insert is locked to the container by means of pins.

In all the embodiments shown in the annexed figures, the metal insert has the shape of a ring. Anyway, according to alternative embodiments, the insert consists of a plurality (for example two of e.g. 180° or three of e.g. 120° or four of e.g. 90°) sectors adjacent to each other or separate and (a little) distant from each other; furthermore, the sectors may be fixed to each other.

In all the embodiments shown in the annexed figures, the metal insert is fully inside the container. Anyway, according to alternative embodiments, the insert reach one or more the outside surfaces of the container (and act partially also as a wall of the container).

It is to be understood that even though numerous characteristics and advantages of various embodiments have been set forth in the foregoing description, together with details of the structure and functions of various embodiments, this disclosure is illustrative only, and changes may be made in detail, especially in matters of structure and arrangement of parts within the principles of the embodiments to the full extent indicated by the broad general meaning of the terms in which the appended claims are expressed. It will be appreciated by those skilled in the art that the teachings disclosed herein can be applied to other systems without departing from the scope and spirit of the application.

What is claimed is:

1. A method of manufacturing a component of a turbomachine by powder metal hot isostatic pressing, using a container defining outside surfaces of the component; the method comprising:
providing a metal insert located inside the container;
filling the container with a metal powder;
leaving the insert in the component after the end of its manufacturing; and
removing a core from the component before the end of its manufacturing by pickling and/or by machining.

2. The method of claim 1, further comprising removing the container from the component before the end of its manufacturing, or leaving the container, at least partially, in the component after the end of its manufacturing.

3. The method of claim 1, further comprising providing a metal core located inside the container before filling the container with the metal powder.

4. The method of claim 1, wherein the insert is a bulk insert in a single piece or in a plurality of pieces.

5. The method of claim 4, wherein the plurality of pieces are separate, in contact and adjacent to each other so to form a single body within the metal powder before filling the container.

6. The method of claim 4, wherein the plurality of pieces are separate and in contact with each other so to form a plurality of bodies within the metal powder before filling the container.

7. The method of claim 4, wherein the plurality of pieces are distant from each other so that metal powder may interpose, the distance being in the range from 0.5 mm to 5.0 mm.

8. The method of claim 1, wherein the insert has at least one surface adjacent to the container.

9. The method of claim 1, wherein the insert has at least one surface adjacent to the core.

10. The method of claim 1, wherein the insert has at least one surface adjacent to the container and at least one surface adjacent to the core.

11. The method of claim 1, wherein the insert is manufactured by powder metal hot isostatic pressing, additive manufacturing, forging, or casting.

12. The method of claim 1, wherein the metal material of the insert and the metal material of the powder are the same.

13. A component of a turbomachine, the component manufactured by a method of powder metal hot isostatic pressing, using a container defining outside surfaces of the component, the method comprising:
providing a metal insert located inside the container;
filling the container with a metal powder;
leaving the insert in the component after the end of its manufacturing; and
removing a core from the component before the end of its manufacturing by pickling and/or by machining.

14. The component of claim 13, wherein the component is a closed impeller of a centrifugal compressor.

15. The component of claim 13, comprising a metal insert.

16. The component of claim 15, wherein the insert is a bulk insert in a single piece or in a plurality of pieces.

17. The component of claim 15, wherein the insert is ring-shaped or disk-shaped.

18. The component of claim 16, wherein the ring-shaped or disk-shaped insert is divided in two or three or four or five or six or seven or eight or more identical or different sectors.

19. The component of claim 15, wherein an external surface of the insert is an external surface of the component.

20. The component of claim 15, wherein an external surface of the insert is an internal surface of the component.

21. The component of claim 15, wherein a surface of the insert has protrusions or is corrugated or textured or rough.

22. A turbomachine comprising at least one component, the component manufactured by a method of powder metal hot isostatic pressing, using a container defining outside surfaces of the component, the method comprising:
providing a metal insert located inside the container;
filling the container with a metal powder;
leaving the insert in the component after the end of its manufacturing; and
removing a core from the component before the end of its manufacturing by pickling and/or by machining.
